(19) United States
(12) Patent Application Publication
(10) Pub. No.: US 2018/0145984 A1
(43) Pub. Date: May 24, 2018

(54) SYSTEM AND METHOD FOR PROVIDING SECURITY SOLUTIONS TO PROTECT ENTERPRISE CRITICAL ASSETS

(71) Applicants: Rajender Duggal, Lincoln, MA (US); Dhanesh D. Pai, Bengaluru (IN); Surender Raju Yerram, Hyderabad (IN); Kishore Adduri, Hyderabad (IN); Virupaksh Gudagunti, Bengaluru (IN)

(72) Inventors: Rajender Duggal, Lincoln, MA (US); Dhanesh D. Pai, Bengaluru (IN); Surender Raju Yerram, Hyderabad (IN); Kishore Adduri, Hyderabad (IN); Virupaksh Gudagunti, Bengaluru (IN)

(21) Appl. No.: 15/414,651

(22) Filed: Jan. 25, 2017

(30) Foreign Application Priority Data
Nov. 24, 2016 (IN) 201641040096

(51) Int. Cl. H04L 29/06

(52) U.S. Cl. CPC H04L 63/10; H04L 63/0281; H04L 63/08

(57) ABSTRACT

Exemplary embodiments of the present disclosure are directed towards a system and method for providing security solutions to protect enterprise critical assets. The system comprise a plurality of service requesting host devices enrolled with at least one authentication and authorization unit for accessing a plurality of enterprise applications by a plurality of users, wherein the plurality of enterprise applications provided by a plurality of service providing host devices. The system further comprises an enterprise security service gateway platform configured to accept communication from the plurality of service requesting host devices for encrypted communications through the authentication and authorization unit to the plurality of service providing host devices. The enterprise security service gateway platform interfaces with the plurality of service providing host devices and makes them invisible in a connected network to the plurality of users except the ones authenticated and authorized to use the services.

### TECHNICAL FIELD

The present disclosure generally relates to the field of enterprise security systems. More particularly, the present disclosure relates to a system and method for providing security solutions to protect enterprise critical assets.

### BACKGROUND

Generally a distributed computing system, or computer networks relates to a technique of authentication to the users in the distributed computing context. In this type of distributed computing environment, some systems function as “servers” and others function as “clients” of the servers. Client implies the device and the user using the device. A client system makes request from the server system for service and the server requires “authentication” of the user before the service is provided. In some cases, the client requires that the server to be authenticated to make sure that someone is not posing as the server. Client authentication implies the presence of a security mechanism whereby the server can verify that the client is authorized to receive the requested service.

Client devices request to access the enterprise resource to authenticate on a computing resource before accessing any services provided by that computing resource (referred to as server). Typically, client devices must communicate with server resources for authentication and authorization before being granted access. Additionally, to authenticate the client device each time it requests access to an enterprise resource. These frequent communications provide for wear and tear on the client device and result in wasted network resources.

Normally the communication between the client and the server is not secure which can be passively snooped by the potential hacker.

In the light of aforementioned discussion there exists a need for certain systems with novel methodologies for providing security solutions to protect enterprise critical assets that would overcome or ameliorate the above mentioned disadvantages.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for providing security solutions to protect enterprise critical assets.

According to an exemplary aspect, the system includes a plurality of service requesting host devices enrolled with at least one authentication and authorization unit for accessing a plurality of enterprise applications by a plurality of users, wherein the plurality of enterprise applications provided by a plurality of service providing host devices.

According to an exemplary aspect, the system includes an enterprise security service gateway platform configured to accept communication from the plurality of service requesting host devices for encrypted communications through the authentication and authorization unit to the plurality of service providing host devices, whereby the enterprise security service gateway platform interfaces with the plurality of service providing host devices and makes them invisible and inaccessible in a connected network to the plurality of users except the ones authenticated and authorized to use the services.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a block diagram depicting a system for providing security solutions to protect enterprise critical assets, according to exemplary embodiments of the present disclosure.

Controller and the Gateway access same database server which contains multiple tables.

FIG. 2 is a block diagram depicting a user authentication and authorization unit for providing security solutions to protect enterprise critical assets, according to exemplary embodiments of the present disclosure.

FIG. 3 is a block diagram depicting an enterprise security service gateway platform, according to exemplary embodiments of the present disclosure.

FIG. 4 is a flow diagram depicting a method for providing security solutions to protect enterprise critical assets, according to exemplary embodiments of the present disclosure.

FIG. 5 is a flow diagram depicting a method for accessing employee share point services, according to exemplary embodiments of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

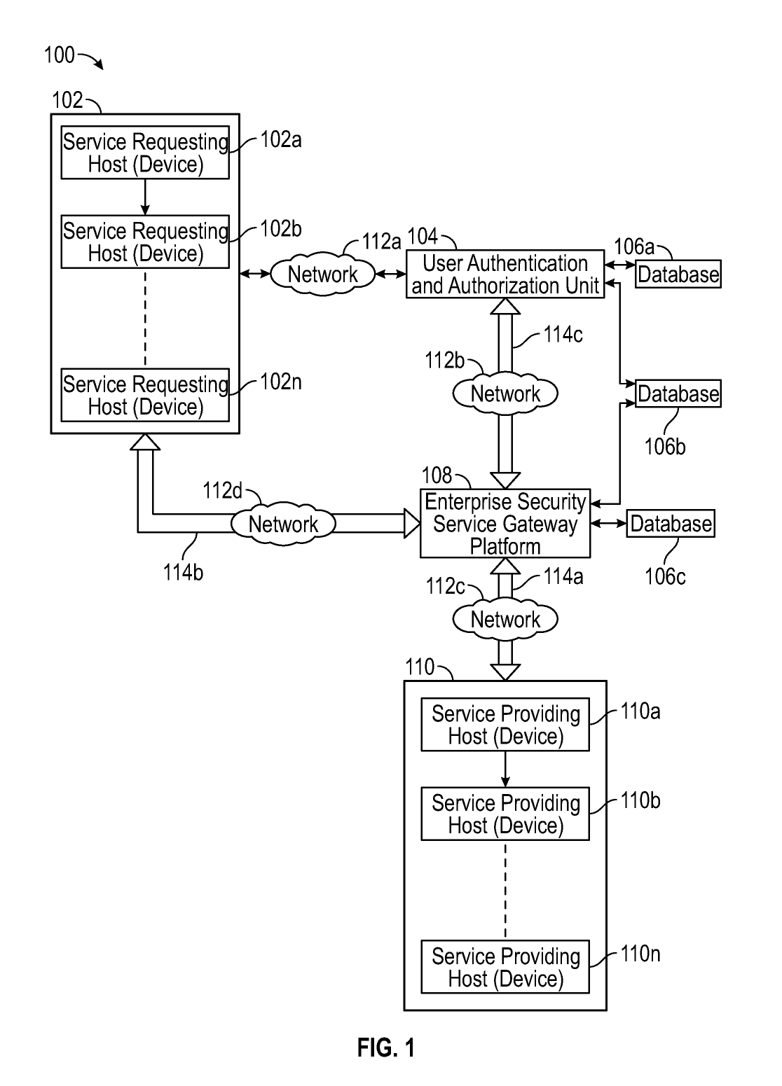

Referring to FIG. 1 is a block diagram 100 depicting a system for providing security solutions to protect enterprise critical assets, according to exemplary embodiments of the present disclosure. The system 100 includes a service requesting unit 102, a user authentication and authorization unit (multiple device, device OS, device hardware characteristics, device network interface characteristics, device agent software, device user attributes and the binding of all these attributes is used for authentication and authorization) 104, databases 106a-106c, an enterprise security service gateway platform 108, service providing unit 110 and a network 112a-112d. The service requesting unit 102 further includes service requesting host devices 102a-102n. The service providing unit 110 further includes service providing host devices 110a-110n. The enterprise critical assets may include, but not limited to, enterprise software applications and the like. The network 112a-112d may be a local area network (LAN), a wide area network (WAN), or a combination of different networks, an internet or any cellular network by way of cellular technology such as GSM (global system for mobile communications), CDMA (code division multiple access), and AMPS (advanced mobile phone system).

According to non-limiting exemplary embodiments of the present disclosure, the service requesting host devices 102a-102n may include, but not limited to, mobile device, personal computer, laptop, tablet, and the like. The service providing host devices 110a-110n includes enterprise servers hosts protected enterprise applications. The service requesting host devices 102a-102n are used to access the protected enterprise applications hosted on the service providing host devices 110a-110n. Users may use the service requesting host devices 102a-102n for providing necessary framework and data to the user authentication and authorization unit 104 for the device registration, subscriber authentication and authorization.

According to non-limiting exemplary embodiments of the present disclosure, each service requesting host devices 102a-102n are connected to the network 112a-112d and authenticates to the user authentication and authorization unit 104. The service requesting host devices 102a-102n initiates a mutual connection to the authorized service providing hosts 110a-110n. The user authentication and authorization unit 104 instructs the enterprise security service gateway platform 108 to accept communication from the service requesting host devices 102a-102n as well as any optional policies required for encrypted communications. After authenticating the service requesting host devices 102a-102n, the user authentication and authorization unit 104 determines a list of service providing host devices 110a-110n as well as applicable security policies required for secure communication to the service requesting host devices 102a-102n.

According to non-limiting exemplary embodiments of the present disclosure, the enterprise security service gateway platform 108 acts as a proxy for the service providing host devices 110a-110n and establishes secure data tunnels 114a-114c with the service requesting host devices 102a-102n and multiplexes the session data of the service requesting host devices 102a-102n into the secure data tunnels 114a-114c to set up with the service providing host devices 110a-110n. During the active data session between the service requesting host devices 102a-102n and the service providing host devices 110a-110n, in case there are any changes in the factors affecting the authentication of either service providing unit 110 or service requesting unit 102, the enterprise security service gateway platform 108 tears down the session depending on the policy. The user authentication and authorization unit 104 is connected to the database 106a and the enterprise security service gateway platform 108 is connected to the database 106c. The database 106b which is interface between the user authentication and authorization unit 104 and the enterprise security service gateway platform 108. The database 106b may act as a shared database to provide access to the user authentication and authorization unit 104 and the enterprise security service gateway platform 108.

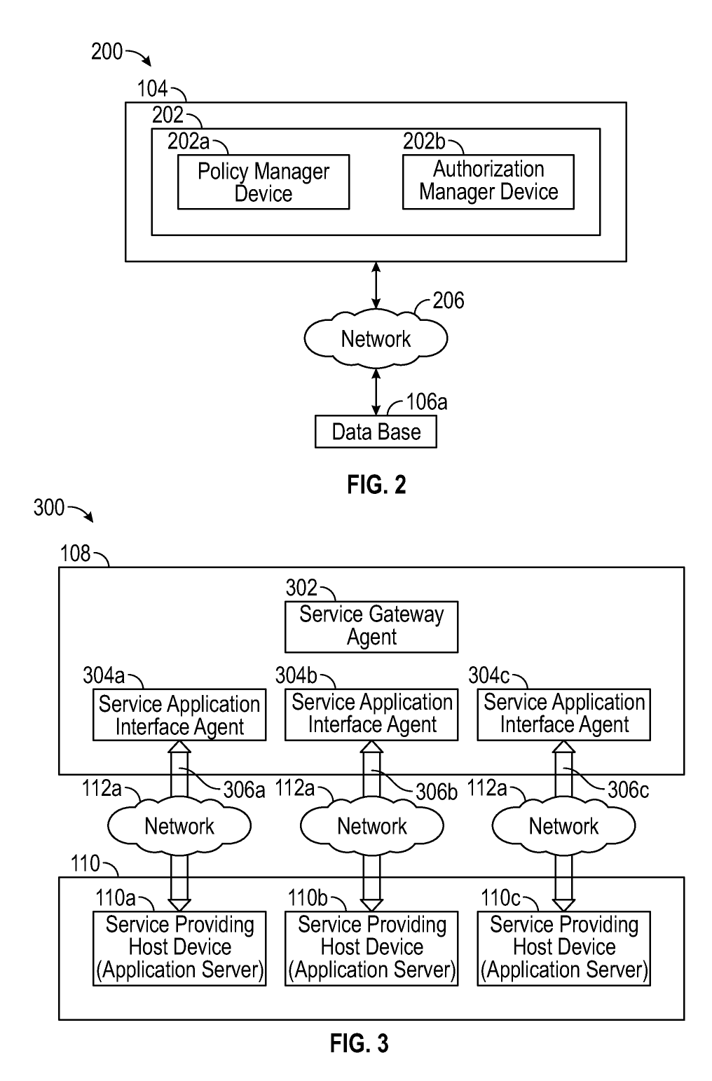

Referring to FIG. 2 is a block diagram 200 depicting a user authentication and authorization unit for providing security solutions to protect enterprise critical assets, according to exemplary embodiments of the present disclosure. The user authentication and authorization unit 104 includes service controller devices 202 for device registration, subscriber authentication and authorization. The service controller devices 202 may include, not limited to, a policy manager device 202a, and an authorization manager device 202b. The policy manager device 202a and the authorization manager device 202b interface with the database 106a through a network 206. The database 106a may include, but not limited to, an active directory database, a certificate database, a subscriber identity management database and an enterprise policy database.

According to non-limiting exemplary embodiments of the present disclosure, the user authentication and authorization unit 104 may request device related information such as hardware or software inventory from the users of the service requesting host devices 102a-102n before providing information related to the services. The user authentication and authorization unit 104 collects the data for user behaviour analytics and uses challenge framework whenever behaviour deviation is detected for additional verification.

According to non-limiting exemplary embodiments of the present disclosure, the user authentication and authorization unit 104 registers with the service controller devices 202a-202b. The user authentication and authorization unit 104 is topped by the behaviour analytics, may include, but not limited to, transport type TCP (Transmission Control Protocol) or UDP (User datagram protocol), transport layer port number for service (Key), location information (coordinates), software inventory information, hardware inventory information, current IP address, MAC address, hardware serial number, blue tooth ID (if any), device subscriber name, device subscriber password, device's passive foot print, device's active foot print, hash of all the Info using agent's private key and the like. The service controllers ensure the other modules in the user authentication and authorization unit 104 are authorized and authentic.

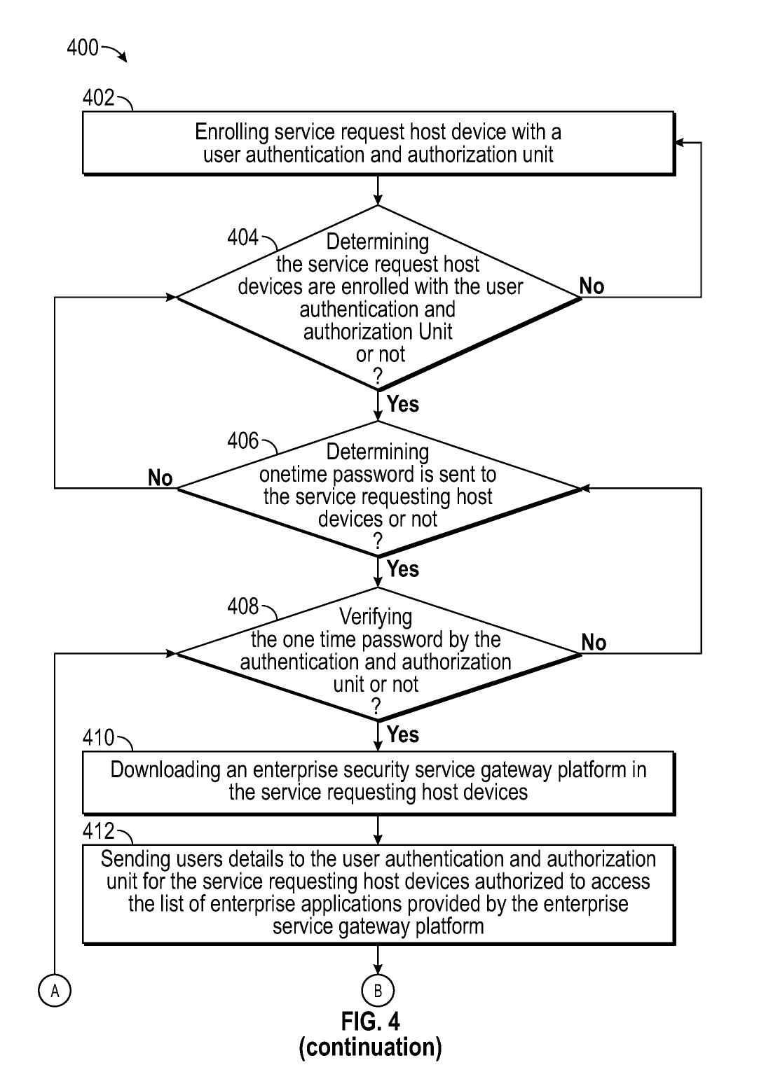

Referring to FIG. 3 is a block diagram 300 depicting an enterprise security service gateway platform, according to exemplary embodiments of the present disclosure. The security service gateway platform 108 includes a service gateway agent 302, service application interface agent's 304a-304c. The service gateway agent 302 may be connected to the user authorization and authentication unit 104, the service requesting host devices 102a-102n through the network 112b, 112d. The service application interface agents 304a-304c are connected to the service providing host devices 110a-110n through the network 112a. The service application interface agents 304a-304c are establish secure data tunnels 306a-306c with the service providing host devices (application servers) 110a-110c.

According to non-limiting exemplary embodiments of the present disclosure, the security service gateway platform 108 interfaces with the service providing host devices (application servers) 110a-110n and makes them invisible in the connected network 112a, 112d and also to all the users except the ones authenticated and authorized to use the services. The security gateway agent 302 is executed on the security service gateway platform 108 and configured to establish the secure data tunnels 114a-114c among service requesting host devices 102a-102n and the service providing host devices (application servers) 110a-110n, once the authentication and authorization is complete. The service application interface agents 304a-304c may be configured to execute on the security service gateway platform 108 and helps in authenticating the users with the security service gateway platform 108 based on the authentication protocol followed by the application. The credentials required for the authentication are fetched from the security gateway agent 302.

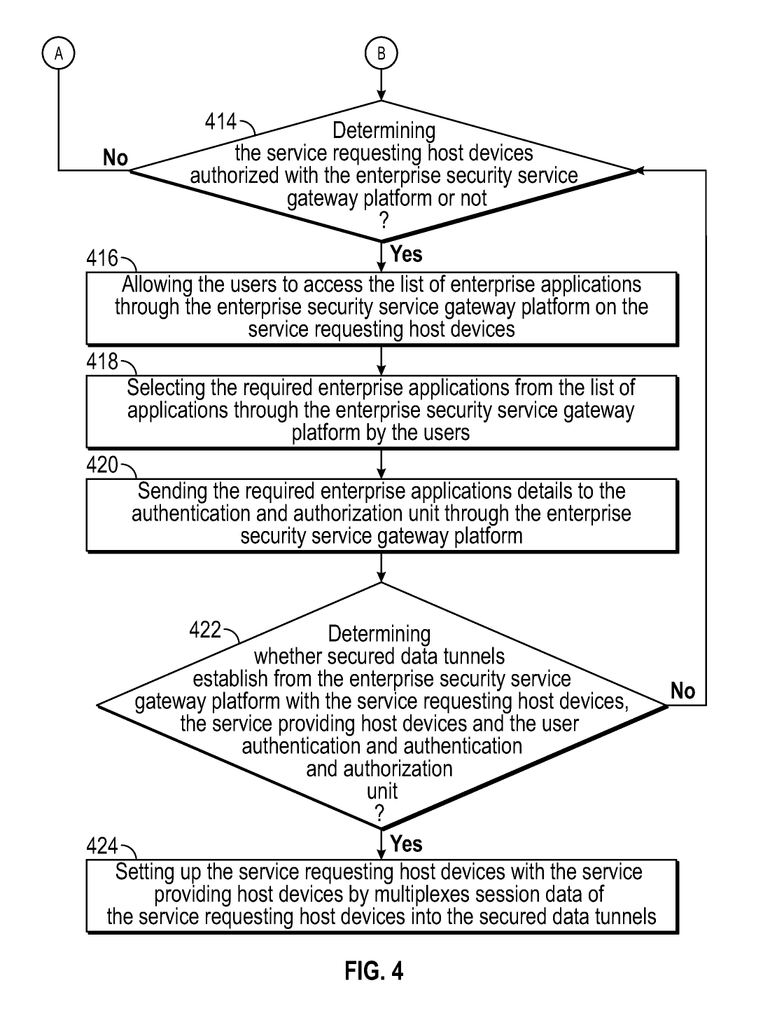

Referring to FIG. 4 is a flow diagram 400 depicting a method for providing security solutions to protect enterprise critical assets, according to exemplary embodiments of the present disclosure. As an option, the method 400 may be carried out in the context of the details of FIG. 1, FIG. 2, and FIG. 3. However, the method 400 may also be carried out in any desired environment. Further, the aforementioned definitions may equally apply to the description below.

The method starts at step 402 by enrolling service request host devices with a user authentication and authorization unit by users. Validation is performed to determine the service request host devices are enrolled with the user authentication and authorization unit or not, at step 404. If the answer to the validation at step 404 is NO, then the method goes at step 402. If the answer to the validation at step 404 is YES, then the method continues to next step 406 wherein a validation is performed to determine if a onetime password is sent to the service requesting host devices or not. If the answer to the validation at step 406 is NO, then the method repeats to step 404. If the answer to the validation at step 406 is YES, then the method continues to next step 408 validation is performed to verify the one time password by the authentication and authorization unit or not. If the answer to the validation at step 408 is NO, then the method repeats to step 406. If the answer to the validation at step 408 is YES, then the method continues to next step 410 download an enterprise security service gateway platform in the service requesting host devices by the users. Here, the enterprise security service gateway platform may be connected to service providing host devices to provide a list of enterprise applications.

The user's details may be sent to the user authentication and authorization unit for the service requesting host devices authorized to access the list of enterprise applications provided by the enterprise security service gateway platform, at step 412. Validation is performed to determine the service requesting host devices authorized with the enterprise security service gateway platform or not, at step 414. If the answer to the validation at step 414 is NO, then the method repeats to step 408. If the answer to the validation at step 414 is YES, then the method continues to next step 416 allowing the users to access the list of applications through the enterprise security service gateway platform on the service requesting host devices. The users may select the required enterprise applications from the list of applications through the enterprise security service gateway platform, at step 418. The selected required applications details may be sent to the authentication and authorization unit through the enterprise security service gateway platform by the users, at step 420. Validation is performed to determine whether secure data tunnels establish from the enterprise security service gateway platform with the service requesting host devices, the service providing host devices and the user authentication and authorization unit, at step 422. Here, the enterprise security service gateway platform acts as a proxy for the service providing host devices. If the answer to the validation at step 422 is NO, then the method repeats to step 414. If the answer to the validation at step 422 is YES, then the method continues to next step 424 the service requesting host devices set up with the service providing host devices by multiplexes session data of the service requesting host devices into the secure data tunnels.

More illustrative information will now be set forth regarding various optional architectures and uses in which the foregoing method may or may not be implemented, as per the desires of the user. It should be strongly noted that the following information is set forth for illustrative purposes and should not be construed as limiting in any manner. Any of the following features may be optionally incorporated with or without the exclusion of other features described.

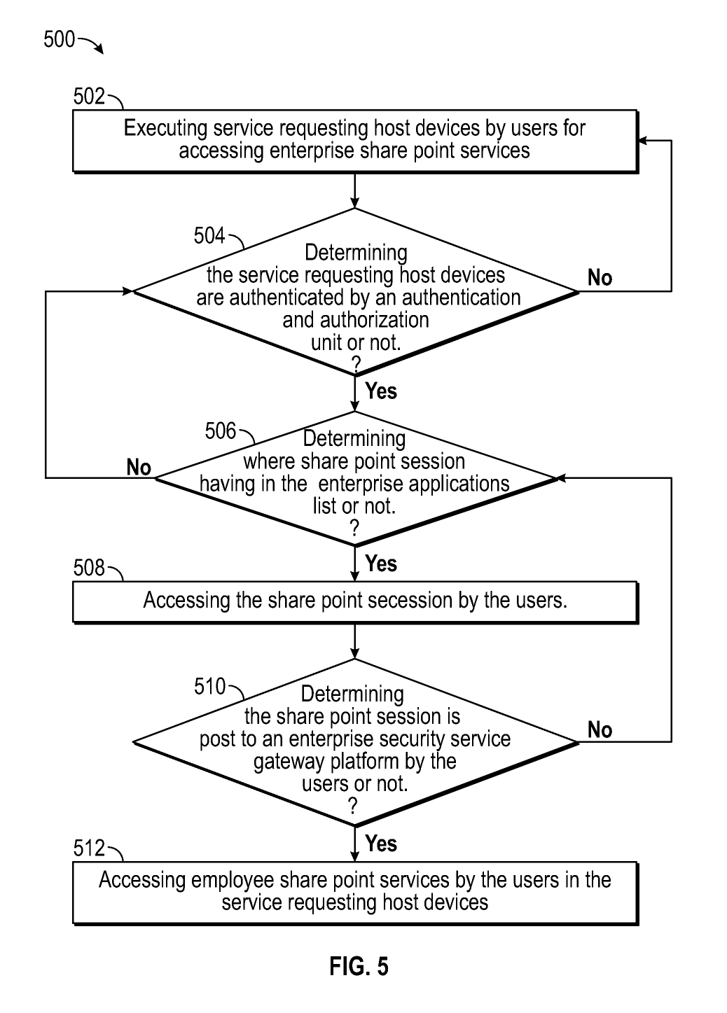

Referring to FIG. 5 is a flow diagram 500 depicting a method for accessing employee share point services, according to exemplary embodiments of the present disclosure. As an option, the method 500 may be carried out in the context of the details of FIG. 1, FIG. 2, FIG. 3 and FIG. 4. However, the method 500 may also be carried out in any desired environment. Further, the aforementioned definitions may equally apply to the description below.

The method commences at step 502 by service requesting host devices are executed by users for accessing enterprise share point services. Validation is performed at step 504 where service requesting host devices are authenticated by an authentication and authorization unit or not. If the answer to validation at step 504 is NO, then the method repeats to step 502. If the answer to validation at step 504 is YES, then the enterprise applications list may appear in the service requesting host devices by the authentication and authorization unit. Validation is performed at step 506 where the enterprise applications list having a share point session or not. If the answer to validation at step 506 is NO, then the method repeats to step 504. If the answer to validation at step 506 is YES, then the method continues to next step 508 the users may access the share point session. Validation is performed at step 510 where share point session is post to an enterprise security service gateway platform and a share point server by the users or not. If the answer to validation at step 510 is NO, then the method repeats to step 506. If the answer to validation at step 510 is YES, then the method continues to next step 512 access employee share point services by the users in the service requesting host devices. For example, the employee share point services may include, not limited to documents, site pages, calendar and the like.

More illustrative information will now be set forth regarding various optional architectures and uses in which the foregoing method may or may not be implemented, as per the desires of the user. It should be strongly noted that the following information is set forth for illustrative purposes and should not be construed as limiting in any manner. Any of the following features may be optionally incorporated with or without the exclusion of other features described.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A system for providing security solutions to protect enterprise critical assets, comprising:
a plurality of service requesting host devices enrolled with at least one authentication and authorization unit for accessing a plurality of enterprise applications by a plurality of users, wherein the plurality of enterprise applications provided by a plurality of service providing host devices; and
an enterprise security service gateway platform configured to accept communication from the plurality of service requesting host devices for encrypted communications through the authentication and authorization unit to the plurality of service providing host devices, whereby the enterprise security service gateway platform interfaces with the plurality of service providing host devices and makes them invisible in a connected network to the plurality of users except the ones authenticated and authorized to use the services.

2. The system of claim 1, wherein the enterprise security service gateway platform comprises a security gateway agent device establishes a plurality of secure data tunnels with the plurality of service requesting host devices to set up session data with the plurality of service providing host devices by a service gateway agent through the user authentication and authorization unit.

3. The system of claim 1, wherein the plurality of service requesting host devices accessed by the plurality of users to initiate a mutual connection to the plurality of authorized service providing host devices.

4. The system of claim 1, wherein the user authentication and authorization unit is configured to support various authentication and authorization services of the plurality of users.

5. The system of claim 1, wherein the enterprise security service gateway platform acts as a proxy for the plurality of service providing host devices.

6. The system of claim 1, wherein the user authentication and authorization unit further comprises a plurality of service controller devices for the plurality of users devices registration, authentication and authorization.

7. The system of claim 6, wherein the plurality of service controller devices are registered with the enterprise security service gateway platform by a plurality of service controllers.

8. The system of claim 1, wherein the enterprise security service gateway platform further comprises a plurality of application agent devices configured to authenticate the plurality of users with the plurality of enterprise applications by a plurality of service application interface agents.

9. A method for providing security solutions to protect enterprise critical assets, comprising:
enrolling a plurality service request host devices with a user authentication and authorization unit by a plurality of users, wherein the user authentication and authorization unit configured to support a plurality of authentication and authorization services;
authenticating the plurality of service requesting host devices to an enterprise security service gateway platform by the plurality of users, wherein the enterprise service gateway platform register with a plurality of service controllers;
determining a plurality of service providing host devices to the plurality of service requesting devices after authentication, wherein the service requesting devices are authorized to communicate with the plurality of service providing host devices;
accepting a communication from the plurality of service requesting host devices by the enterprise security service gateway platform, wherein the plurality of service controllers instruct the enterprise security service gateway platform to accept communication from the plurality of service requesting host devices and makes the plurality of service providing host devices invisible in a connected network to the plurality of users except the ones authenticated and authorized to use the services;
providing the plurality service providing host devices to the plurality of service requesting host devices by the plurality of service controllers, wherein the plurality of service providing host devices configured to provide a plurality of enterprise applications; and
initiating mutual secure connection to the plurality of authorized service providing host devices by the plurality of users on the plurality of service requesting host devices; and establishing a plurality of secure data tunnels from the enterprise security service gateway platform with the plurality of service requesting host devices, whereby the plurality of service requesting host devices set up with the plurality of service providing host devices by multiplexes session data of the service requesting host devices into the plurality of secure data tunnels.
